(19) United States
(12) Patent Application Publication
(10) Pub. No.: US 2023/0325732 A1
(43) Pub. Date: Oct. 12, 2023

(54) PLANNING SYSTEM AND PLANNING METHOD

(71) Applicant: Hakuhodo DY Holdings Inc., Tokyo (JP)

(72) Inventors: Koichiro YAMAOKA, Tokyo (JP); Ryo DOMOTO, Tokyo (JP); Ryoji MINAMI, Tokyo (JP); Tomoaki SANO, Tokyo (JP); Jumpei IMURA, Tokyo (JP); Ryoma YASUNAGA, Tokyo (JP)

(21) Appl. No.: 18/025,540

(22) PCT Filed: Sep. 8, 2021
(86) PCT No.: PCT/JP2021/033051

§ 371 Date: Mar. 9, 2023

(30) Foreign Application Priority Data
Sep. 9, 2020 (JP) 2020-151641

(51) Int. Cl. G06Q 10/0631

(52) U.S. Cl. CPC G06Q 10/06311

(57) ABSTRACT

A system in one aspect of the present disclosure calculates prediction values related to multiple sites. Based on the prediction values, there is generated a touring plan in which a touring person tours two or more sites as touring destinations corresponding to at least some of the multiple sites and an outcome expected to be brought from touring satisfies a specific condition. The outcome includes an outcome to be brought from an activity of the touring person in each destination. As the touring plan, there can be generated a touring plan showing at least one of a touring order or a touring time for the two or more sites. Information on the touring plan generated is output.

### CROSS-REFERENCE TO RELATED APPLICATION

This international application claims the benefit of Japanese Patent Application No. 2020-151641 filed on Sep. 9, 2020 with the Japan Patent Office, the entire disclosure of which is incorporated herein by reference.

### TECHNICAL FIELD

The present disclosure relates to a planning system and a planning method.

### BACKGROUND ART

There has been a study on technology to support business activities (for example, see, Patent Document 1). In conventional technology, business outcomes and histories of business activities associated with the business outcomes are accumulated as performance data. Based on the performance data accumulated, a recommendation on business activities expected to result in satisfactory outcomes is produced.

### PRIOR ART DOCUMENTS

### Patent Documents

Patent Document 1: Japanese Unexamined Patent Application Publication No. 10124584 A

### SUMMARY OF THE INVENTION

### Problems to be Solved by the Invention

However, the relation between business activities and outcomes is not simple; the outcomes vary depending on various factors such as an environment to perform the business activities.

According to one aspect of the present disclosure, it is desirable to be able to provide a planning system and method that can improve outcomes to be resulted from touring with respect to touring activities to visit multiple sites.

### Means for Solving the Problems

One aspect of the present disclosure provides a planning system that generates a touring plan. The planning system comprises a predictor, a generator, and an outputter. The predictor is configured to calculate prediction values related to multiple sites.

The generator is configured to generate the touring plan based on the prediction values. The touring plan is a plan for a touring person to tour two or more sites as touring destinations corresponding to at least some of the multiple sites. The touring plan is a plan in which an outcome to be expected from touring satisfies a specific condition.

The outcome includes an outcome to result from an activity of the touring person in each touring destination of the touring destinations. The generator generates, as the touring plan, a touring plan showing at least one of a touring order or a touring time for the two or more sites. The outputter is configured to output information on the travel plan generated.

The planning system in one aspect of the present disclosure may output information on a touring plan having a high outcome expected based on the prediction values related to the multiple sites. Utilizing the planning system can improve the outcome related to a touring activity.

In one aspect of the present disclosure, at least one site of the multiple sites may be a distribution hub for products. In this case, the prediction values may include at least one of a prediction value of a parameter related to distribution of the products in the distribution hub or a prediction value of a parameter related to a distribution operator.

The business activities sometimes involve touring distribution hubs. The planning system in one aspect of the present disclosure can improve the outcome related to the touring activity aiming for such a business activity.

In one aspect of the present disclosure, the outcome to be considered in generating the touring plan may vary depending on a state of the each touring destination. In this case, the prediction values may include a prediction value related to the state of each site of the multiple sites at each time point of multiple time points. Utilizing the prediction value related to the state enables the generator to predict the outcome with satisfactory accuracy, to thereby generate a satisfactory touring plan.

In one aspect of the present disclosure, the generator may generate the touring plan based on an individual outcome value for every combination of a site and a time point. The individual outcome value may be calculated based on the prediction values. The individual outcome value may be a value representing an amount of the outcome to be expected from the activity of the touring person in a corresponding site and at a corresponding time point. Utilizing such an individual outcome value facilitates prediction of an outcome of the whole touring plan including two or more sites as touring destinations.

In one aspect of the present disclosure, the predictor may be configured to collect a performance value of a parameter related to the state and calculate the prediction values based on the performance value collected. Such a configuration enables generation of a satisfactory touring plan based on a prediction value less deviated from an actual value.

In one aspect of the present disclosure, at least one site of the multiple sites may be a business hub of a business operator. The prediction values may include, for the each time point, a prediction value related to a reception environment of the business operator when the touring person visits the business hub at the corresponding time point.

In one aspect of the present disclosure, the prediction value related to the reception environment may include a prediction value related to an event in which the touring person succeeds a meeting with a person with a specific attribute in the business operator when the touring person visits the business hub at the corresponding time point.

Business activities and the like involve working on business operators. In such activities, an outcome to be expected increases or decreases depending on reception environments of the business operators. Thus, the planning system utilizing the prediction value related to the reception environment of the business operator can generate a favorable touring plan.

In one aspect of the present disclosure, the predictor may collect report data showing report details related to the reception environment from the touring person, and calculate, as the prediction value related to the reception environment, based on the report data, a value representing a degree of possibility (for example, a probability) that the business operator is in a specific reception environment at the corresponding time point. Based on the report data, the reception environment can be accurately predicted.

In one aspect of the present disclosure, the predictor may collect report data showing report details, from the touring person, related to success or failure of the meeting with the person with the specific attribute. Furthermore, the predictor may calculate, as the prediction value related to the event, based on the report data, a value representing a degree of possibility (for example, a probability) that the touring person succeeds the meeting with the person with the specific attribute when the touring person visits the business hub at the corresponding time point.

In one aspect of the present disclosure, the predictor may be configured to calculate the prediction values in light of an activity of a company competing with the touring person. The state of the each touring destination may vary depending on the activity of the competitor. There may be various outcomes to be expected from the same touring plan depending on the activity of the competitor. Thus, the planning system taking into consideration the competitor can generate more favorable touring plan.

In one aspect of the present disclosure, the activity of the touring person may include two or more types of activities that are performable in the corresponding site to the each touring destination. The touring plan may further show a type of activity to be performed by the touring person in the corresponding site to the each touring destination. The generator may generate the touring plan based on an outcome to be expected for every combination of the site, the time point, and/or the type of activity. Such a planning system can generate a favorable touring plan for a touring activity with a broad range of activity.

In one aspect of the present disclosure, the generator may generate, as the touring plan to be output from the outputter, a touring plan having an overall outcome value maximized or one or more touring plans having the overall outcome value equal to or greater than a standard when an individual outcome value is calculated for every combination of a site and a time point based on the prediction values. The individual outcome value is an outcome to be expected when the touring person performs one type of activity of the multiple types of activities in the corresponding site at the corresponding time point. The overall outcome value is calculated based on individual outcome values, each of which is based on the touring time and the one type of activity for a corresponding site of the two or more sites corresponding to the touring destinations.

In one aspect of the present disclosure, the overall outcome value is calculated by integrating the individual outcome values corresponding to the outcomes to be expected from the touring for the respective two or more sites when the touring is performed for the each site of the two or more sites in accordance with the touring plan and an activity of a type conforming to the touring plan is performed in the each site.

In one aspect of the present disclosure, the activity of the touring person may include an activity related to at least one of selling products or providing services. The activity of the touring person may include activities related to two or more types of products or two or more types of services. The touring plan may further show a type of product and/or a type of service to be targeted by the touring person in the activity in the corresponding site to the each touring destination.

In one aspect of the present disclosure, the outcome may be expressed as a performance evaluation indicator related to the at least one of the selling of the products or the providing of the services.

In one aspect of the present disclosure, the activity of the touring person may include arranging a display shelf displaying the products. The state may include a state of the display shelf in the corresponding site. The predictor may calculate, as the prediction value related to the state at the each time point, a prediction value related to the state of the display shelf at the corresponding time point based on a state of the display shelf in the past.

Although the arranging of the display shelf is related to how well the products are sold, it is inefficient to visit the corresponding site when the arranging is not required. The planning system in one aspect of the present disclosure can reduce such an inefficient touring.

In one aspect of the present disclosure, the at least one site of the multiple sites may include a site to perform, for customers, the at least one of the selling of the products or the providing of the services. The state may include a visit number of the customers of the corresponding site. The generator may generate the touring plan based on a prediction value related to the visit number. It is helpful to improve the outcome when the touring plan is generated, taking into consideration increase or decrease of the visit number.

In one aspect of the present disclosure, the generator may generate the touring plan conforming to a restriction condition predetermined in relation to behavior of the touring person. The restriction condition may include at least one of: a restriction condition related to at least one of a touring start time or a touring end time of the touring person; a restriction condition related to at least one of a travelling time or a travelling distance of the touring person; a restriction condition related to travelling means of the touring person; or a restriction condition related to at least one of the number of touring or a touring time to one or more sites of the multiple sites.

The planning system above can output information on the touring plan that is easy for the touring person to adopt. Alternatively, the planning system above can reduce occurrence of undesired imbalance in each site in respect of the number of touring and the touring time.

In one aspect of the present disclosure, there may be provided a computer program to cause a computer to at least partially achieve a function as the planning system above. In one aspect of the present disclosure, there may be provided a computer program to cause a computer to function as the predictor, the generator, and the outputter in the planning system above.

In one aspect of the present disclosure, there may be provided a computer-implemented planning method. The method may include calculating prediction values related to multiple sites; generating a touring plan based on the prediction values, the touring plan being a plan for a touring person to tour two or more sites as touring destinations corresponding to at least some of the multiple sites, and the touring plan being a plan in which an outcome to be expected from touring satisfies a specific condition; and outputting information on the touring plan generated.

The outcome may include an outcome to result from an activity of the touring person in each touring destination. The generating may include generating a touring plan, as the touring plan, showing at least one of a touring order or a touring time for the two or more sites.

In one aspect of the present disclosure, the outcome may include an outcome varying in accordance with a state of the each touring destination. The activity of the touring person may include multiple types of activities that are performable in a corresponding site to the each touring site.

The touring plan may be a touring plan showing the touring order and the touring time for the two or more sites. The prediction values may include a prediction value related to the state of each site of the two or more sites at each time point of multiple time points. At least one of the two or more sites may be a business hub of a business operator.

The calculating of the prediction values may include collecting report data related to a reception environment of the business operator, and calculating, as a prediction value related to the state of the business hub, based on the report data, a value representing a degree of possibility that the business operator is in a specific reception environment when the salesperson visits at the corresponding time point.

The generating may include generating, as the touring plan to be output, a touring plan having an overall outcome value maximized or one or more touring plans having the overall outcome value equal to or greater than a standard when an individual outcome value is calculated for every combination of a site and a time point based on the prediction values. The individual outcome value may be an outcome to be expected when the touring person performs one type of activity of the multiple types of activities in the corresponding site at the corresponding time point. The overall outcome value may be calculated based on individual outcome values, each of which is based on the touring time and the one type of activity for a corresponding site of the two or more sites corresponding to the touring destinations.

The overall outcome value may be calculated by integrating the individual outcome values corresponding to the outcomes to be expected from the touring for the respective two or more sites when the touring is performed for the each site of the two or more sites in accordance with the touring plan and an activity of a type conforming to the touring plan is performed in the each site.

In one aspect of the present disclosure, there may be provided a computer program comprising instructions to cause a computer to perform the planning method described above. The computer program may be stored in a computer-readable, non-transitory storage medium and provided thereby.

### BRIEF DESCRIPTION OF THE DRAWINGS

FIG. 1 is a block diagram showing an overall configuration of a support system.

FIG. 2 is a block diagram showing an overall configuration of a planning system.

FIG. 3 is a block diagram showing components of establishment data.

FIG. 4 is a flowchart showing a data storing process to be perform by a processor.

FIG. 5 is a diagram showing overall components of report data to be provided by a salesperson.

FIG. 6 is a flowchart showing a plan-generating process to be performed by the processor according to a first embodiment.

FIG. 7 is a flowchart showing a prediction process to be performed by the processor.

FIG. 8 is a diagram explaining an example display screen of a touring plan.

FIG. 9 is a flowchart showing a plan-generating process to be performed by the processor according to a second embodiment.

### EXPLANATION OF REFERENCE NUMERALS

1 . . . support system, 10 . . . planning system, 11 . . . processor, 12 . . . memory, 13 . . . storage, 19 . . . communication interface, 30 . . . mobile device, 60 . . . external server, DR . . . report data

### MODE FOR CARRYING OUT THE INVENTION

Hereinafter, example embodiments of the present disclosure will be described with reference to drawings.

### First Embodiment

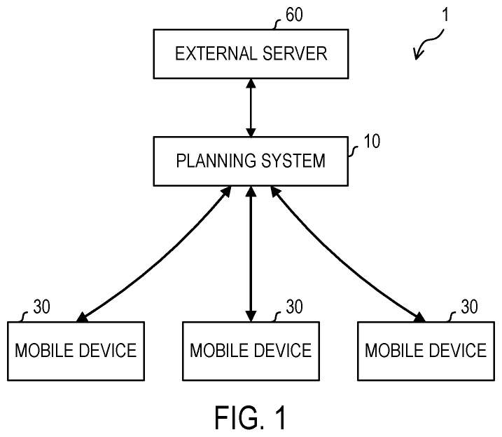

FIG. 1 illustrates a support system 1 in the present embodiment.

The support system 1 is a system to support a touring activity of a salesperson who tours multiple commercial establishments exhibiting and selling products. The touring activity of the salesperson is performed, for example, so that the salesperson promotes or supports sales of products of a company he/she belongs to, or products exhibited in the commercial establishments.

The commercial establishments referred herein are not limited in size, and include, for example, a small retail store operated in a limited space inside a building. The commercial establishments are related to distribution from retailers to consumers, and correspond to one example of the distribution hub. Moreover, the commercial establishments correspond to one example of the business hub for retailers. Hereinafter, the commercial establishments are simply expressed as “establishment(s)”. For example, it is important for cosmetic manufacturers to have salespersons perform the touring activity to the establishments.

In the support system 1, a planning system 10 collects data from two or more mobile devices 30 of two or more salespersons and collects data from an external server 60, to thereby provide each salesperson with information on a touring plan via a corresponding one of the mobile devices 30.

The touring plan to be provided to the salesperson corresponds to a schedule to visit two or more establishments corresponding to at least some of multiple establishments for which the salesperson is responsible. The touring plan explains an order to visit each establishment and a time to visit each establishment. The travel plan provided further includes information on a travelling means and a travelling route to each establishment. The salesperson can tour two or more establishments in accordance with the touring plan to be provided by the planning system 10.

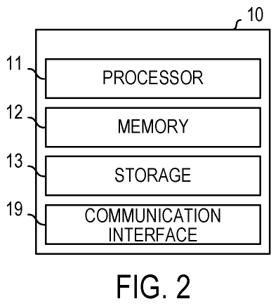

As shown in FIG. 2, the planning system 10 comprises a processor 11, a memory 12, a storage 13, and a communication interface 19. The processor 11 is configured to perform a process in accordance with a computer program stored in the storage 13.

The memory 12 is used as a working space during the processor 11 performing the process in accordance with the computer program. The communication interface 19 is configured to be communicable with the mobile device 30 and the external server 60 via a wide area network.

The storage 13 comprises, for example, a hard disc drive. The storage 13 stores data required to search for a satisfactory touring plan. For example, the storage 13 stores data for every establishment. Hereinafter, data for every establishment is referred to as “establishment data”.

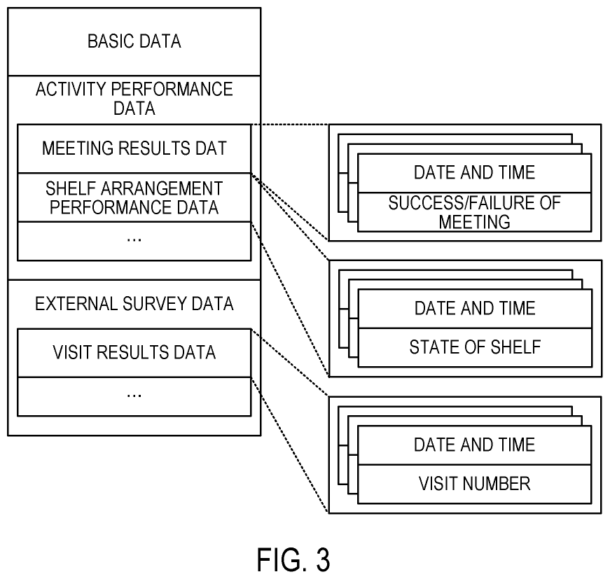

FIG. 3 shows one establishment data related to one establishment. This establishment data includes basic data, activity performance data, and external survey data. The basic data includes a position coordinate indicating the location of the establishment, business hours, and commercial goods handled by the establishment. The basic data further includes, as information on the touring activity, identification information of the salesperson responsible for the establishment, and information on what frequency and time the salesperson should visit the establishment.

The activity performance data consists of a set of performance data related to touring activities to the corresponding establishment. The activity performance data includes, for example, meeting results data and shelf arrangement performance data as the performance data to describe details of activities in the corresponding establishment.

The meeting results data includes, for every visit to the establishment by the salesperson, information indicating date and time of the visit to the establishment, and whether the meeting with a key person has been successful. The meeting results data may further include information specifically describing details of business negotiation.

The key person corresponds to a person in a business operator managing the establishment, and corresponds to a person authorized to stock products. In other words, the key person corresponds to a person in a position who may be influenced by a business activity of the salesperson through the meeting, leading to a possible consequence that the establishment increases an order quantity of products targeted by the salesperson in the business activity. The key person corresponds to a person with a specific attribute in the business operator.

The shelf arrangement performance data includes, for every visit of the salesperson to the establishment, information indicating date and time of the visit to the establishment and a state of a display shelf at the time of the visit. Examples of the information indicating the state of the display shelf may include, for every commercial goods, information on an amount of commercial goods displayed before the display shelf is arranged and an amount of commercial goods displayed after the display shelf is filled with the commercial goods as a result of shelf arrangement. The shelf arrangement corresponds to a practice to arrange display of the commercial goods in the shelf so as to fill the shelf with the commercial goods. Furthermore, the shelf arrangement corresponds to a practice to optionally arrange the shelf in an exhibiting manner to encourage consumers to purchase the product.

The external survey data is stored in the storage 13 based on the data collected from the external server 60. The external survey data includes visit results data indicating the visit number of the consumers of the corresponding establishment for every date and time.

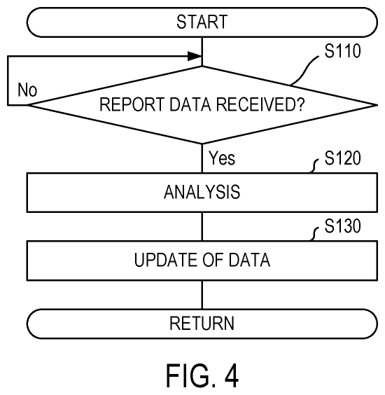

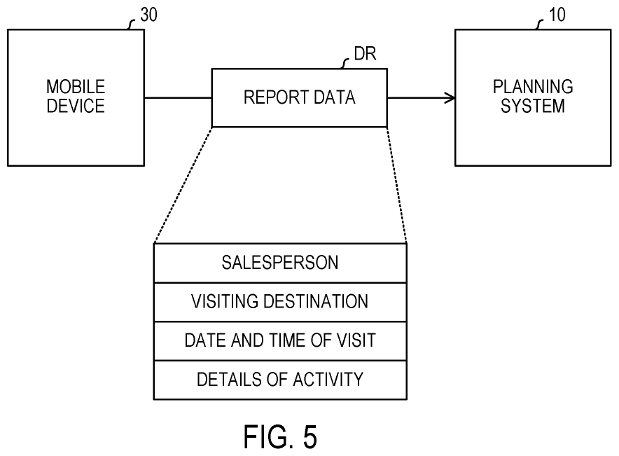

The processor 11 repeatedly performs the data storing process shown in FIG. 4 in accordance with the computer program, to thereby update the activity performance data in the storage 13 based on report data DR received from the mobile device 30 as shown in FIG. 5.

Upon starting the data storing process shown in FIG. 4, the processor 11 waits until receiving the report data DR from a corresponding one of the two or more mobile devices 30 via the communication interface 19 (S110). The report data DR includes details of report on the touring activity by the salesperson.

Each mobile device 30 is configured to create the report data DR based on an operation of the mobile device 30 by the salesperson, and transmit the report data DR to the planning system 10. The report data DR is created for every visit to the establishment visited in the touring activity, and is transmitted to the planning system 10.

The report data DR shown in FIG. 5 by way of example includes identification information of the salesperson, identification information of a visiting destination, the information on date and time of the visit, and information on activity details. The information on the activity details describes details of the activity performed by the salesperson in the visiting destination and includes information indicating whether the meeting with the key person has been successful.

Upon receiving the report data DR (S110: Yes), the processor 11 analyzes the report data DR received (S120). Based on the report data DR received, the processor 11 updates the corresponding activity performance data (S130).

Furthermore, the processor 11 regularly accesses the external server 60 via the communication interface 19. The processor 11 analyzes the data collected by accessing the external server 60, to thereby update the external survey data in the storage 13. Accordingly, the planning system 10 stores and updates the activity performance data and the external survey data, which are required for searching for a satisfactory touring plan.

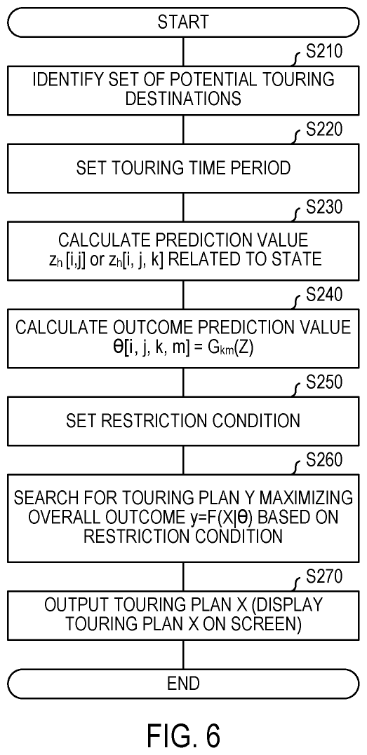

Still further, upon receiving a request to output the touring plan (output request) from a corresponding one of the two or more mobile devices 30 via the communication interface 19, the processor 11 performs the plan-generating process shown in FIG. 6. The output request may be transmitted from the mobile device 30 to the planning system 10 as a result of, for example, the salesperson operating the mobile device 30.

Upon starting the plan-generating process, the processor 11 identifies a set of potential touring destinations (S210). The set of potential touring destinations means a set of establishments selectable as touring destinations, in other words, visiting destinations, in generating the touring plan. The processor 11 can identify a salesperson from which the output request is transmitted, to thereby identify the set of potential touring destinations as the set of establishments for which this salesperson is responsible.

The processor 11 further sets a touring time period (S220). The touring time period corresponds to a time period which the touring plan is performed. The time period may be, for example, a specific number of days from the next day.

Subsequently, the processor 11 calculates, for every time point in the touring time period and every establishment corresponding to the set of potential touring destinations, a prediction value zₕ [i, j] of each state parameter zₕ(h=1, 2, 3 . . . ) at a corresponding time point i in a corresponding establishment j (S230). The index “i” indicates a time point, and the index “j” indicates an establishment.

The state parameter zₕ(h=1, 2, 3 . . . ) is a parameter to indicate a state of the establishment, in particular, a chronologically varying state of the establishment. Depending on the type of the state parameter zₕ(h=1, 2, 3 . . . ), a prediction value zₕ[i, j, k] is calculated for every combination of the time point, the establishment, and/or the commercial goods. The index “k” indicates the commercial goods. One commercial goods k is defined as one product or a group of products consisting of two or more products similar to one another.

Examples of the prediction value of the state parameter zₕ include a reception prediction value z₁[i, j], a visiting prediction value z₂ [i, j], and a display prediction value z₃ [i, j, k]. The reception prediction value z₁ [i, j] is a prediction value related to a reception environment of the business operator at the time point i when the salesperson visits the establishment j. The visiting prediction value z₂ [i, j] is a prediction value of the visit number of the consumers of the establishment j at the time point i. The display prediction value z₃ [i, j, k] is a prediction value of an amount of the commercial goods k displayed in the establishment j at the time point i.

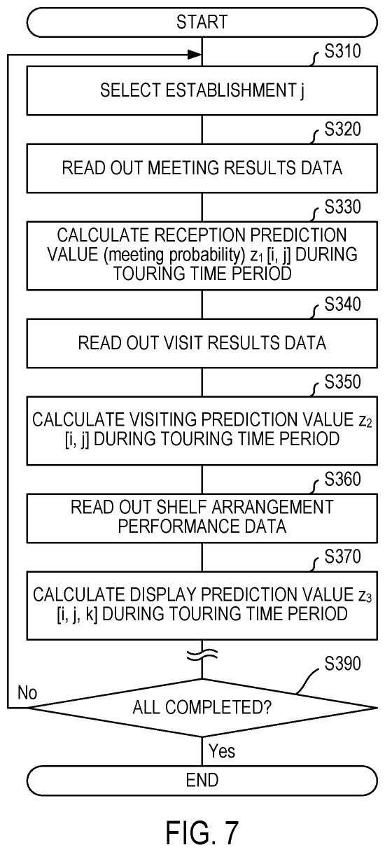

In S230, the processor 11 can perform a prediction process shown in FIG. 7. Upon starting the prediction process, the processor 11 selects one establishment from the set of potential touring destinations as an establishment to be predicted (S310).

The processor 11 reads out the meeting results data from the establishment data of the establishment selected (S320). Based on the meeting results data read out, the processor 11 calculates a meeting probability related to the establishment j selected above at each time point i, as the reception prediction value z₁ [i, j] at each time point i of the touring time period (S330). The meeting probability related to the establishment j at the time point i is a probability that the salesperson succeeds the meeting with the key person in the business operator when the salesperson visits the establishment j at the time point i.

As discussed above, the meeting results data includes a record of success or failure of the meeting for every date and time. The meeting probability z₁ [i, j] can be calculated using the Bayesian inference approach based on conditional probabilities. The conditional probabilities are related to, for example, a possibility that the meeting is successful and a possibility that the meeting fails, which are determined based on the meeting results data.

Furthermore, the processor 11 reads out the visit results data based on the establishment data of the establishment selected above (S340). Based on the visit results data read out, the processor 11 calculates a prediction value of the visit number of consumers who visit the selected establishment j at the time point i as the visiting prediction value z₂ [i, j] at each time point i of the touring time period (S350).

For example, the processor 11 may perform an auto-regression analysis for the visit results data, to thereby enable construction of the regression equation for calculating the visiting prediction value z₂ [i, j] based on a performance value of the visit number during a specific time period in the past. The visiting prediction value z₂ [i, j] can be calculated based on the regression equation.

The processor 11 further reads out the shelf arrangement performance data based on the establishment data of the selected establishment (S360). Based on the shelf arrangement performance data read out, the processor 11 calculates the display prediction value z₃ [i, j, k] of each commercial goods k at each time point i of the touring time period (S370).

The processor 11 may perform an analysis for the shelf arrangement performance data, to thereby enable calculation of a decrease curve representing decrease of each commercial goods from the display shelf. The processor 11 may calculate the display prediction value z₃ [i, j, k] related to the amount of each commercial goods k displayed at each time point i based on an amount of the commercial goods displayed at a time point when the display shelf is last arranged, the decrease curve, and a length of time elapsed since the arrangement of the display shelf.

As discussed above, the processor 11 calculates the prediction value for each state parameter zₕ(h=1, 2, 3 . . . ). Upon calculating prediction values of all the state parameters zₕ(h=1, 2, 3 . . . ), the processor 11 returns to a process of S310, switching establishments to be predicted to thereby perform a process of S320 and subsequent processes. Upon completing calculation of prediction values related to all the establishments corresponding to the set of potential touring destinations (S390: YES), the processor 11 ends the prediction process shown in FIG. 7.

In addition, some of the prediction values of the state parameters zₕ(h=1, 2, 3 . . . ) may be values to be externally provided. Some of the prediction values may be values read out from the storage 13 by the processor 11, in place of values calculated by the processor 11.

For example, the prediction value may be provided by the salesperson through the report data DR. In this case, the prediction value may be based on experience of the salesperson. The prediction value may be a value to be input by a supervisor of the salesperson or a supervisor of the planning system 10, or a value observed in the past.

A description is further given to the state parameter zₕ. There are various parameters to be adopted as the state parameter zₕ that contribute to generation of a satisfactory touring plan. For example, examples of the state parameter zₕ include the following parameters.

Parameter Related to Customers

The examples of the state parameter zₕ can include, other than the visit number of consumers as customers, a parameter representing the degree of interest of the consumers in the establishment with respect to the product. Calculation of the degree of interest can be achieved by obtaining a statistic on whether consumers have seen an online advertisement of the corresponding product based on the external survey data. Information on behavior to see the online advertisement can be collected from mobile devices owned by the consumers.

In addition to or in place of the online advertisement, the degree of interest may be calculated using a statistic on an advertisement through other medium such as a television advertisement. For example, probabilities that the visitors have seen the television commercial may be calculated based on viewer ratings by attributes, particularly, combinations of sex and age, and the degree of interest may be calculated based on the probabilities calculated. For example, when the viewer ratings in males in their 30s is 30% during a time when the television advertisement was broadcasted, a probability that male visitors in their 30s have seen the television advertisement is estimated to be 30%. Based on this estimation, the degree of interest can be calculated.

Parameter Related to Establishment

The examples of the state parameter zₕ can include parameters representing a sales capacity of the establishment for every commercial goods or a sales volume of the establishment for every commercial goods, a volume of delivery to the establishment for every commercial goods, and a state of installation of a promotional item in the establishment. Furthermore, the examples may include a parameter related to a relation between the establishment and the salesperson.

Parameter Related to Products of Company of Salesperson Corresponding to Touring Purpose

The examples of the state parameter zₕ can include parameters representing presence/absence or the sales volume of new products on which the consumers have a high degree of interest, and presence/absence or the distribution amount of the promotional item.

Parameter Related to Activity of Competitor Distinctive from Company of Salesperson

The examples of the state parameter zₕ can include parameters representing the volume of activity of the competitor, presence/absence or the sales volume of new products of the competitor, and presence/absence or the distribution amount of the promotional item of the competitor. These parameters are helpful in predicting an outcome of the touring activity by the salesperson in light of the activity of the competitor.

Parameter Related to Scale of Entire Market Including Competitor

The scale can be evaluated based on, for example, sales and/or sales volume of corresponding commercial goods. The examples of the state parameter zₕ related to the scale can include parameters describing the share of the company of the salesperson in an entire market and the share of the competitor in the entire market.

The state parameter zₕ can include a parameter having a fixed value instead of a value that changes over time.

The processor 11 utilizes the prediction value calculated in S230 to thereby calculate an outcome prediction value θ[i, j, k, m] for every time, establishment, commercial goods, and type of activity (S240). The index “m” indicates the type of activity.

The outcome prediction value θ[i, j, k, m] is a prediction value of an outcome to be brought, in a state explained by the prediction value of the state parameter zₕ(h=1, 2, 3 . . . ), from the salesperson visiting the corresponding establishment j at the corresponding time point j and performing an activity m regarding the commercial goods k among multiple types of activities.

The multiple types of activities include an activity to promote or support product sales in the establishment. Furthermore, the multiple types of activities include a type of activity irrelevant to the commercial goods. Thus, a value to explain the activity irrelevant to the commercial goods can be assigned to the index k representing the commercial goods.

In one example, the outcome can be a score numerically representing a profit of the company of the salesperson resulting from the visiting and the activity. The profit referred herein includes a non-pecuniary profit, and should be broadly interpreted. In a simple example, the outcome can be a score numerically representing an increased amount of orders made by the establishment due to the visiting and the activity, in other words, an increased amount of sales with respect to the establishment.

The outcome prediction value θ[i, j, k, m] can be calculated by substituting a set of prediction values Z of the state parameter zₕ(h=1, 2, 3 . . . ) related to the time point j, the establishment j, and the commercial goods k into a function Gₖₘ (Z) for every type of commercial goods and activity.

For example, the outcome prediction value θ[i, j, k, m] can be calculated, as a value Z, by substituting the reception prediction value z₁[i, j], the visiting prediction value z₂[i, j], and the display prediction value z₃[i, j, k] into the function Gₖₘ(Z) (θ[i, j, k, m]=Gₖₘ(z₁[i, j], z₂[i, j], z₃[i, j, k] . . . )).

Examples of the activity related to the commercial goods k include a business activity for the commercial goods k through the meeting with the key person, arrangement of the display shelf related to the commercial goods k, and installation of the promotional item related to the commercial goods k. Moreover, the outcome to be brought from the arrangement of the display shelf at the time point i varies due to the visit number of consumers at and subsequent to the time i point.

As can be understood from the aforementioned, in some cases, the prediction value Z before or after the time point i can be substituted into the function Gₖₘ(Z) for calculating the outcome prediction value θ[i, j, k, m] at the time point i. The function Gₖₘ(Z) can be defined by a system engineer of the planning system 10.

When the outcome prediction value θ[i, j, k, m] is calculated, there may be a consideration on a relation between establishments, a relation between commercial goods, and a relation between activities. For example, there may be a consideration that geologically adjacent establishments tend to compete with each other for visitors, commercial goods with similar attributes tend to influence each other in respect of the outcome, and the activity to arrange the display shelf tends to facilitate successful negotiation through the meeting. The outcome prediction value θ[i, j, k, m] may be calculated taking into consideration these tendencies, and the function Gₖₘ(Z) for this purpose may be defined.

The function Gₖₘ(Z) has internal parameters that may be adjusted in accordance with a command from the salesperson or the supervisor of the salesperson. For example, when the outcome prediction value θ[i, j, k, m] is calculated based on a weighting sum of the prediction values of the state parameters zₕ, weight coefficients correspond to one example of the internal parameters.

Upon completing a process of S240, the processor 11 sets a restriction condition (S250). The restriction condition to be set includes a restriction condition related to a start time and an end time of the touring of the day that correspond to work hours of the salesperson. For setting of the restriction condition, the storage 13 can store data that describes work hours for every salesperson.

The restriction condition may further include a restriction condition related to a travelling time and a travelling distance per a day. For example, the travelling distance may be a travelling distance along a travelling path that connects multiple touring sites from a start site of the touring activity of the day to an end site of the touring activity of the day in accordance with the touring plan. The travelling time is a sum of travelling times involved in the touring activity of the salesperson per a day excluding a stay time at the visiting destination. The restriction condition may include a restriction condition related to hours worked, in which an activity time (for example, the stay time at the visiting destination) is added to the travelling time.

The restriction condition may further include a restriction condition to restrict travelling means of the salesperson. The travelling means referred herein means an automobile, a public transportation, and the like. Examples of the restriction condition include a restriction condition to restrict the travelling means to walking and the public transportation (including taxi) and a restriction condition to restrict the travelling means to walking and the automobile (company owned-car or private car). For setting of this restriction condition, the storage 13 can store data describing whether touring by the automobile (company owned-car or private car) is possible for every salesperson.

The restriction condition may further include a restriction condition to restrict a visiting frequency and a visiting time for each establishment. For example, there may be a case where the business operator of the establishment limits a day of the week to allow the visit. Furthermore, the search for the touring plan performed in S260 in light of the outcome may find an establishment with an excessively low visiting frequency. In order to suppress such an inappropriate search, the restriction condition to restrict the visiting frequency and the visiting time for the establishment can be set.

Taking into consideration the restriction condition set, the processor 11 searches for a touring plan that maximizes an overall outcome prediction value y using the outcome prediction value θ[i, j, k, m] calculated in S240 (S260).

The overall outcome prediction value y, which is a search index, corresponds to a sum of outcome prediction values θ[i, j, k, m] regarding respective establishments obtained from the visiting and the activity for the respective establishments when the salesperson performs the touring activity in accordance with the touring plan.

That is, the overall outcome prediction value y corresponds to a sum of prediction values θ[i, j, k, m] of the outcome to be obtained when the salesperson tours each establishment k in order in accordance with the touring plan and performs the activity m regarding the commercial goods k in accordance with the touring plan. The overall outcome prediction value y is expressed in the following formula.

$$y = F ( X \vert θ ) = {\sum }_{i , j , k , m} x [ i , j , k , m ] θ [ i , j , k , m ] \qquad [ Formula 1 ]$$

Here, “x[i, j, k, m]” is a variable that takes a value of “1 (one)” if the touring plan X is a touring plan to perform the activity m regarding the commercial goods k in the establishment j at the time point i, and takes a value of “0 (zero)” if the touring plan X is not such a touring plan. If the outcome prediction value θ[i, j, k, m] corresponds to an increased amount of sales of the company of the salesperson, the overall outcome prediction value y also corresponds to an increased amount of the sales.

In S260, there can be a search for the touring plan X having the overall outcome prediction value y maximized within a range that satisfies the restriction condition. Alternatively, in an environment where, as the overall outcome prediction value y is deviated from the range that satisfies the restriction condition, a large negative correction C is added as a penalty to the overall outcome prediction value y, there can be a search for the touring plan X having the overall outcome prediction value y maximized after correction. The correction C can be an output of a function whose input variable is the degree of deviation from the restriction condition.

The processor 11 may search for a touring route and a touring schedule, in advance, that satisfy the restriction condition related to the traveling time, the travelling distance, and the travelling means, to thereby operate to search for the touring plan X having the overall outcome prediction value maximized within a range of the touring route and the touring schedule searched.

The processor 11 can operate with the external server 60 so as to generate the touring plan X taking into consideration the travelling time, the travelling distance, and the travelling means. The external server 60 can have road map data and operation data of the public transportation, and have a function to search for a route to pass through a designated point.

Upon completing the search in S260, the processor 11 outputs the touring plan X having the overall outcome prediction value y maximized, found in the search (S270). For example, the processor 11 transmits, through the communication interface 19, screen data describing the corresponding touring plan X to the mobile device 30, from which output of the touring plan X has been requested, so as to display a screen providing the touring plan X on the mobile device 30 (S270). Subsequently, the processor 11 ends the plan-generating process.

Based on data received from the planning system 10, the mobile device 30 can display, for example, a screen to provide a touring schedule and a travelling route of each day from a departure point of the salesperson through each establishment to be visited back to the departure point, as a description screen to describe the touring plan X.

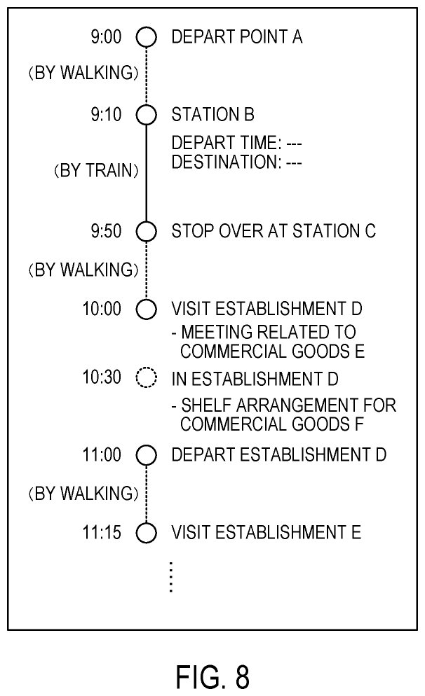

As shown in, for example, FIG. 8, the description screen describes establishments to be toured, which are the establishments to be visited, the order to visit each establishment, the time to visit each establishment, and the type of activity to be performed in each establishment. Regarding the activity to be performed, the description screen designates commercial goods to which the activity is targeted.

The description screen further describes the travelling means to each establishment. Thus, the salesperson who has been provided with the touring plan through the description screen can perform an efficient touring activity that results in a high outcome by visiting each establishment in accordance with the touring plan provided.

In S270, the touring plan X may be output so as to be explained to the salesperson by voice. Alternatively, the touring plan X may be output to the salesperson using virtual reality (VR) or artificial reality (AR) display technology.

Although the support system 1 according to the first embodiment has been described hereinabove, the touring time period and the time point i above may include a time point in the past before the present. That is, the processor 11 may perform the plan-generating process shown in FIG. 7 so as to search for the touring plan X that maximizes the overall outcome prediction value y taking into consideration a performance during a specific past time period before the present, for example, a time period up to one day before the present date or a time period for the past week.

In this case, the outcome prediction value θ[i, j, k, m] and the value of the variable x[i, j, k, m] to be used regarding the time point i in the past before the present each can be a value actually observed or a performance value, not the prediction value.

Considering the touring activity of the salesperson in the past before the present, the search for the touring plan X described above can find the touring plan X conforming to the restriction condition and favorable as a touring plan X of the salesperson in the future from the present, and provide the salesperson with the same.

In addition, the processor 11 may perform the plan-generating process on a regular basis, for example, on a daily basis, to thereby output the latest touring plan to the mobile device 30 without the output request from the mobile device 30. Alternatively, based on a command from the supervisor of the salesperson or another salesperson, the processor 11 may perform the plan-generating process to thereby output the latest touring plan to the mobile device 30. The touring plan to be output to thereby be presented to the salesperson can be for a time period longer than an execution cycle of the plan-generating process such as one week, not for one day.

In this case, the salesperson is provided with the touring plan every day that includes a plan for the same day in the future. However, it is unfavorable for a user when the plan provided changes every day. Thus, in S260, the touring plan may be searched such that the closer a future plan is to an execution date of the touring activity, the greater the penalty is on the future plan for its change from the previous plan. In this case, in the search, the negative correction C may be added to the overall outcome prediction value y as the penalty for the change. In this search, the latest plan is not greatly changed. A plan in the latest few days may not be changed, but only a plan in the future therefrom may be searched and updated.

### Second Embodiment

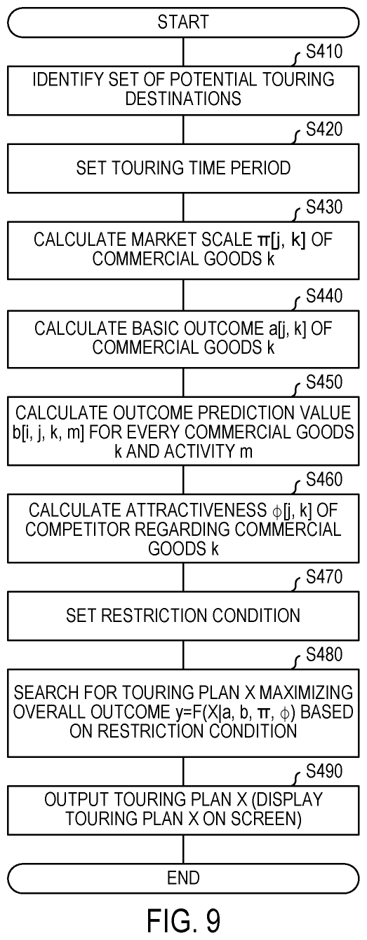

The support system 1 according to a second embodiment to be described below is configured such that the processor 11 of the planning system 10 performs a touring plan-generating process shown in FIG. 9 in place of the touring plan-generating process shown in FIG. 7.

The support system 1 in the second embodiment is configured in the same manner as in the first embodiment, except that details of the touring plan-generating process to be performed by the processor 11 in the second embodiment are different from those in the first embodiment. Hereinafter, a part of the support system 1 in the second embodiment having the same configuration as in the first embodiment is denoted with the same reference numeral, and a description of such a part is appropriately omitted.

In the present embodiment, upon receiving the output request of the touring plan from the mobile device 30, the processor 11 starts the touring plan-generating process shown in FIG. 9. Upon starting the touring plan-generating process, the processor 11 identifies a set of potential touring destinations (S410) in the same manner as in a process of S210. The processor 11 further sets a touring time period (S420) in the same manner as in a process of S220.

Subsequently, the processor 11 calculates a market scale π[j, k] of each commercial goods for every establishment corresponding to the set of potential touring destinations (S430). The market scale π[j, k] numerically represents the market scale of the commercial goods k in the establishment j.

For example, the market scale π[j, k] corresponds to a sales volume or sales of the commercial goods k in the establishment j for a specific time period in the past. The market scale π[j, k] can be identified based on data provided from the external server 60. The market scale π[j, k] may be predicted in accordance with, for example, an autoregressive model, based on the performance data in the past.

The processor 11 further calculates a basic outcome a[j, k], for every establishment, regarding the commercial goods in the corresponding establishment (S440). The basic outcome a[j, k] represents a basic outcome regarding the commercial goods k in the establishment j.

Specifically, the basic outcome a[j, k] corresponds to a profit to be obtained by the company of the salesperson regarding the commercial goods k in the establishment j without the activity of the salesperson in the establishment j through the touring. The basic outcome a[j, k] corresponds to a brand power of the company of the salesperson regarding the commercial goods k in the establishment j.

The processor 11 can analyze the activity performance data in the past for every establishment to thereby calculate the basic outcome a[j, k]. For example, the basic outcome a[j, k] can be calculated based on a relation between the touring frequency and the volume of delivery to the establishment.

The processor 11 further performs a process to calculate an outcome prediction value b[i, j, k, m] for every time point, establishment, commercial goods, and type of activity (S450). The outcome prediction value b[i, j, k, m] corresponds to the outcome prediction value θ[i, j, k, m] in the first embodiment.

That is, the outcome prediction value b[i, j, k, m] is a prediction value of an outcome to be brought, in a state explained by the prediction value of the state parameter zₕ(h=1, 2, 3 . . . ), from the salesperson visiting the corresponding establishment j at the corresponding time point j and performing the activity m regarding the commercial goods k.

The processor 11 further calculates attractiveness ϕ[j, k] of the competitor for every establishment and every commercial goods (S460). The attractiveness ϕ[j, k] corresponds to attractiveness of the competitor regarding the commercial goods k as perceived by the establishment j. Details of the attractiveness ϕ[j, k] will be described later. Here, the competitor means competitors as a whole, not each of one or more competitors.

Upon completing a process of S460, the processor 11 sets a restriction condition (S470) in the same manner as in a process of S250. Subsequently, taking into consideration the restriction condition set, the processor 11 utilizes values calculated in S430 to S460 to thereby search for a touring plan that maximizes the overall outcome prediction value y (S480). It should be noted that the overall outcome prediction value y is defined by the following formula in the present embodiment.

$$\begin{matrix}y = F ( X \vert a , b , π , ϕ ) \\ = {\sum }_{j , k} \{ π [ j , k ] \frac{\begin{matrix}exp ( a [ j , k ] + \\ {\sum }_{i , m} x [ i , j , k , m ] b [ i , j , k , m ] )\end{matrix}}{\begin{matrix}exp ( a [ j , k ] + \\ {\sum }_{i , m} x [ i , j , k , m ] b [ i , j , k , m ] ) + ϕ [ j , k ]\end{matrix}} \}\end{matrix} \qquad [ Formula 2 ]$$

The above formula has the same variable x[i, j, k, m] as in the first embodiment. A description is given to the attractiveness ϕ[j, k] of the competitor. Attractiveness A[j, k] of the company of the salesperson is defined by the following formula.

$$A [ j , k ] = exp ( a [ j , k ] + {\sum }_{í , m} x [ i , j , k , m ] b [ i , j , k , m ] ) \qquad [ Formula 3 ]$$

The attractiveness of the competitor ϕ[j, k] corresponds to a sum of attractiveness A[j, k] of the respective competitors as evaluated based on the formula above in the same manner as in the company of the salesperson. However, it is difficult to specifically understand activities of the respective competitors, which makes it impossible to precisely understand the values of the variable x[i, j, k, m] related to the respective competitors.

To address this, in S460, the attractiveness ϕ[j, k] of the whole competitor can be calculated by statistically estimating the activity of the whole competitor. The attractiveness ϕ[j, k] can be estimated in advance through analysis of activity data of the competitor and stored in the storage 13.

Upon completing the search in S480, the processor 11 outputs the touring plan X having the overall outcome prediction value y maximized, found in the search (S490). Specifically, as in a process of S270, the processor 11 transmits screen data describing the touring plan X to the mobile device 30, from which output of the touring plan X has been requested, so as to display a screen providing the touring plan X on the mobile device 30. Subsequently, the processor 11 ends the plan-generating process.

The search for the touring plan X described above can find a favorable touring plan X taking into consideration the activity and attractiveness of the competitor, and provide the salesperson with the same.

Although the market scale n[j, k], the basic outcome a[j, k], and the attractiveness ϕ[j, k] do not include the index of the time point i, they can be updated in every execution of the plan-generating process or regularly in accordance with the latest actual state. The update enables search for more suitable touring plan. Alternatively, the parameter may be updated in response to an adjustment operation of the salesperson or the supervisor of the salesperson.

[Others]

It is apparent that the present disclosure is not limited to the embodiments described above, and may take various forms. For example, the technique in the present disclosure may be applied to a system to support a touring activity of a medical representative (also referred to as “MR”) of a pharmaceutical company who tours multiple medical facilities, instead of the salesperson who tours multiple establishments. The medical representative can tour the multiple medical facilities in accordance with the touring plan provided by the planning system 10 to thereby provide each medical facility with information on medicines.

The support system 1 may be utilized in a touring activity for multiple establishments that provide one or more services. Even in this case, the planning system 10 can provide the salesperson, via the mobile device 30, with the touring plan that shows the order and the time to visit each establishment, and the type of activity to be performed in each establishment. The activity to be performed in each establishment includes one or more activities to promote or support provision of one or more services in the establishment. The salesperson can perform the touring activity to promote or support provision of the services in the establishments in accordance with the touring plan presented by the planning system 10.

Regarding the type of activity, there may be a first type of activity having contents completely different from contents of a second type of activity. Alternatively, the first type of activity may be a type activity having contents partially in common with the second type of activity. Two activities having respective activity contents at least partially different from each other are different types of activities. For example, an activity including the shelf arrangement and the meeting with the key person may be understood as a type of activity different from an activity including the shelf arrangement, but not including the meeting with the key person.

The outcome prediction values θ, b, and the overall outcome prediction value y may be a performance evaluation indicator (also referred to as “key performance indicator (KPI)”) different from the sales. The planning system 10 may be configured to search for the touring plan X using the performance evaluation indicator different from the sales. Examples of the performance evaluation indicator different from the sales can include the volume of delivery of the commercial goods to the establishment and the degree of satisfaction of the customers.

In place of the touring plan having the overall outcome prediction value y maximized, the planning system 10 may generate two or more touring plans having the overall outcome prediction values y equal or higher than the standard, and provide the salesperson with the two or more touring plans. In this case, the salesperson can select one touring plan of the two or more touring plans provided, and perform the touring activity in accordance with the one touring plan selected.

Regarding an outcome to be expected when the salesperson performs, for every combination of the establishment and the time point, one activity among two or more types activities in the corresponding establishment at the corresponding time point to the combination, the processor 11 can calculate the outcome as individual outcome prediction values θ, b based on the prediction values of the state parameter zₕ.

The overall outcome prediction value y is calculated based on the outcome prediction values θ, b corresponding to the touring time and the type of activity for each establishment of the two or more establishments corresponding to the touring destinations. The planning system 10 can generate, as a touring plan to be output, a touring plan having the overall outcome prediction value y maximized. Alternatively, the planning system 10 can generate one or more touring plans having the overall outcome prediction value y equal to or higher than the standard.

The overall outcome prediction value y can be calculated by integrating the outcome prediction values θ, b corresponding to outcomes of the respective establishments to be expected by the touring when the touring is performed for the two or more establishments in accordance with the touring plan and an activity of a type conforming to the touring plan is performed in each establishment.

Examples of calculating the overall outcome prediction value y by integrating multiple outcome prediction values θ, b corresponding to multiple establishments include summing up the multiple outcome prediction values θ, b, calculating a weighting sum of the multiple outcome prediction values θ, b, and calculating a value obtained by adding a correction to the weighting sum.

Furthermore, examples of the touring destination include a site to provide commercial goods and/or services that is provided with a machine to sell the commercial goods and/or provide the services such as a vending machine. In addition, the technique in the present disclosure can be applied to a touring activity of a touring person for a purpose different from business. The technique in the present disclosure may be utilized to manage a touring person.

A function performed by a single element in the above-described embodiments may be divided into two or more elements. Two or more functions performed by two or more elements may be integrated into one element. A part of a configuration in the above-described embodiments may be omitted. Regarding the above-described embodiments, at least a part of the configuration of one embodiment may be added to, or may replace, the configuration of another embodiment. Any and all modes encompassed by the technical ideas specified by the languages in the claims are embodiments of the present disclosure.

1. A planning system comprising:
a predictor configured to calculate prediction values related to multiple sites;
a generator configured to generate a touring plan based on the prediction values, the touring plan being a plan for a touring person to tour two or more sites as touring destinations corresponding to at least some of the multiple sites, and the touring plan being a plan in which an outcome to be expected from touring satisfies a specific condition; and
an outputter configured to output information on the touring plan generated,
wherein the outcome includes an outcome to result from an activity of the touring person in each touring destination of the touring destinations, and
wherein the generator generates, as the touring plan, a touring plan showing at least one of a touring order or a touring time for the two or more sites.

2. The planning system according to claim 1,
wherein at least one site of the multiple sites is a distribution hub for products, and
wherein the prediction values include at least one of a prediction value of a parameter related to distribution of the products in the distribution hub or a prediction value of a parameter related to a distribution operator.

3. The planning system according to claim 1,
wherein the outcome varies depending on a state of the each touring destination, and
wherein the prediction values include a prediction value related to the state of each site of the multiple sites at each time point of multiple time points.

4. The planning system according to claim 3,
wherein the generator generates the touring plan based on an individual outcome value for every combination of a site and a time point, the individual outcome value being calculated based on the prediction values, and
wherein the individual outcome value represents an amount of the outcome to be expected from the activity of the touring person at a corresponding site and a corresponding time point.

5. The planning system according to claim 3,
wherein the predictor is configured to:
collect a performance value of a parameter related to the state; and
calculate the prediction values based on the performance value collected.

6. The planning system according to claim 3,
wherein at least one site of the multiple sites is a business hub of a business operator, and
wherein the prediction values include, for the each time point, a prediction value related to a reception environment of the business operator when the touring person visits the business hub at the corresponding time point.

7. The planning system according to claim 6,
wherein the prediction value related to the reception environment includes a prediction value related to an event in which the salesperson succeeds a meeting with a person with a specific attribute in the business operator when the touring person visits the business hub at the corresponding time point.

8. The planning system according to claim 6,
wherein the predictor collects report data showing report details related to the reception environment from the touring person, and calculates, as the prediction value related to the reception environment, based on the report data, a value representing a degree of possibility that the business operator is in a specific reception environment at the corresponding time point.

9. The planning system according to claim 7,
wherein the predictor collects report data showing report details, from the touring person, related to success or failure of the meeting with the person with the specific attribute, and calculates, as the prediction value related to the event, based on the report data collected, a value representing a degree of possibility that the touring person succeeds the meeting with the person with the specific attribute when the touring person visits the business hub at the corresponding time point.

10. The planning system according to claim 3,
wherein the activity of the touring person includes multiple types of activities that are performable in a corresponding site to the each touring destination,
wherein the touring plan further shows a type of activity to be performed by the touring person in the corresponding site to the each touring destination, and
wherein the generator generates the touring plan based on an outcome to be expected for every combination of a site, the time point, and/or the type of activity.

11. The planning system according to claim 1,
wherein the outcome includes an outcome to result from the activity of the touring person in the each touring destination, the outcome varying depending on a state of the each touring destination, and the activity of the touring person including multiple types of activities that are performable in a corresponding site to the each touring destination,
wherein the touring plan is a touring plan showing the touring order and the touring time for the two or more sites,
wherein the prediction values include a prediction value related to the state of each site of the multiple sites at each time point of multiple time points,
wherein at least one site of the multiple sites is a business hub of a business operator,
wherein the predictor collects report data related to a reception environment of the business operator, and calculates, as a prediction value related to the state of the business hub, based on the report data, a value representing a degree of possibility that the business operator is in a specific reception environment when the touring person visits the business hub at a corresponding time point,
wherein the generator generates, as the touring plan to be output from the outputter, a touring plan having an overall outcome value maximized or one or more touring plans having the overall outcome value equal to or greater than a standard when an individual outcome value is calculated for every combination of a site and a time point based on the prediction values,
wherein the individual outcome value is an outcome to be expected when the touring person performs one type of activity of the multiple types of activities in the corresponding site at the corresponding time point,
wherein the overall outcome value is calculated based on individual outcome values, each of which is based on the touring time and the one type of activity for a corresponding site of the two or more sites corresponding to the touring destinations; and
wherein the overall outcome value is calculated by integrating the individual outcome values corresponding to the outcomes to be expected from the touring for the respective two or more sites when the touring is performed for the each site of the two or more sites in accordance with the touring plan and an activity of a type conforming to the touring plan is performed in the each site.

12. The planning system according to claim 3,
wherein the activity of the touring person includes an activity related to at least one of selling products or providing services.

13. The planning system according to claim 12,
wherein the activity of the touring person includes activities related to two or more types of products and/or two or more types of services as the activity related to the at least one of the selling of the products or the providing of the services, and
wherein the touring plan further shows a type of product and/or a type of service to be targeted by the touring person in the activity in the corresponding site to the each touring destination.

14. The planning system according to claim 12,
wherein the outcome is expressed as a performance evaluation indicator related to the at least one of the selling of the products or the providing of the services.

15. The planning system according to claim 12,
wherein the activity of the touring person includes arranging a display shelf displaying the products,
wherein the state includes a state of the display shelf in the corresponding site, and
wherein the predictor calculates, as the prediction value related to the state at the each time point, a prediction value related to the state of the display shelf at the corresponding time point based on a state of the display shelf in the past.

16. The planning system according to claim 12,
wherein the at least one site of the multiple sites includes a site to perform, for customers, the at least one of the selling of the products or the providing of the services,
wherein the state includes a visit number of the customers of the corresponding site,
wherein the predictor calculates a prediction value related to the visit number of the corresponding site, and
wherein the generator generates the touring plan based on the prediction value related to the visit number.

17. The planning system according to claim 1,
wherein the generator generates the touring plan conforming to a restriction condition predetermined in relation to behavior of the touring person, and
wherein the restriction condition includes at least one of:
a restriction condition related to at least one of a touring start time or a touring end time of the touring person;
a restriction condition related to at least one of a travelling time or a traveling distance of the touring person;
a restriction condition related to travelling means of the touring person; or
a restriction condition related to at least one of the number of touring or a touring time to one or more site of the multiple sites.

18. A computer-implemented planning method comprising:
calculating prediction values related to multiple sites;
generating a touring plan based on the prediction values, the touring plan being a plan for a touring person to tour two or more sites as touring destinations corresponding to at least some of the multiple sites, and the touring plan being a plan in which an outcome to be expected from touring satisfies a specific condition; and
outputting information on the touring plan generated,
the outcome including an outcome to result from an activity of the touring person in each touring destination of the touring destinations, and
the generating including generating, as the touring plan, a touring plan showing at least one of a touring order or a touring time for the two or more sites.

19. A computer-implemented planning method comprising:
calculating prediction values related to multiple sites;
generating a touring plan based on an outcome to be expected from touring, the touring plan being a plan for a touring person to tour two or more sites as touring destinations corresponding to at least some of the multiple sites; and
outputting information on the touring plan generated,
wherein the outcome includes an outcome to result from an activity of the touring person in each touring destination, the outcome varying depending on a state of the each touring destination, and the activity of the touring person including multiple types of activities that are performable in a corresponding site to the each touring destination of the touring destinations,
wherein the touring plan is a touring plan showing a touring order and a touring time for the two or more sites,
wherein the prediction values include a prediction value related to the state of each site of the multiple sites at each time point of multiple time points,
wherein at least one site of the multiple sites is a business hub of a business operator, wherein the calculating of the prediction values includes:
collecting report data related to a reception environment of the business operator; and
based on the report data, calculating, as a prediction value related to the state of the business hub, a value representing a degree of possibility that the business operator is in a specific reception environment when the touring person visits the business hub at a corresponding time point,
wherein the generating includes generating, as the touring plan to be output, a touring plan having an overall outcome value maximized or one or more touring plans having the overall outcome value equal to or greater than a standard when an individual outcome value is calculated for every combination of a site and a time point based on the prediction values,
wherein the individual outcome value is an outcome to be expected when the touring person performs one type of activity of the multiple types of activities in the corresponding site at the corresponding time point,
wherein the overall outcome value is calculated based on individual outcome values, each of which is based on the touring time and the one type of activity for a corresponding site of the two or more sites corresponding to the touring destinations, and
wherein the overall outcome value is calculated by integrating the individual outcome values corresponding to the outcomes to be expected from the touring for the respective two or more sites when the touring is performed for the each site of the two or more sites in accordance with the touring plan and an activity of a type conforming to the touring plan is performed in the each site.

20. The method to generate a plan according to claim 19,
wherein the report data includes report data related to success or failure of a meeting with a person with a specific attribute in the business operator, and
wherein the calculating of the prediction values includes calculating, as the value representing the degree of possibility that the business operator is in the specific reception environment, based on the report data, a value representing a degree of possibility that the touring person succeeds the meeting with the person with the specific attribute when the salesperson visits the business hub at the corresponding time point.

21. (canceled)
